(19) United States
(12) Patent Application Publication
(10) Pub. No.: US 2011/0200723 A1
(43) Pub. Date: Aug. 18, 2011

(54) REDUCED CALORIE FLAVORED MILK OR DAIRY BEVERAGE

(75) Inventors: Adam A. Southwick, Waltham, MA (US); Manoj G. Nair, Chelmsford, MA (US); Peter T. Zoltai, Newburyport, MA (US)

(73) Assignee: HP Hood LLC

(21) Appl. No.: 13/029,667

(22) Filed: Feb. 17, 2011

Related U.S. Application Data
(60) Provisional application No. 61/305,886, filed on Feb. 18, 2010.

(51) Int. Cl. A23C 9/152; A23C 3/02; A23C 9/156; A23C 9/154; A23C 9/158

(52) U.S. Cl. 426/330.2; 426/584

(57) ABSTRACT

The products and methods of the invention relate to reduced-calorie flavored milk products, such as chocolate milk. In particular, the products described herein have all natural sweeteners, and have less than 135 calories per serving. Also described are methods of producing reduced-calorie flavored milk products.

This application claims priority to U.S. Provisional Application No. 61/305,886, filed Feb. 18, 2010, which is incorporated by reference in its entirety.

Obesity in the United States has doubled in the past 25 years. It is a significant contributor of increased health care issues and costs. The rise of obesity has been linked to an increase in caloric intake. There has recently been an increased push to address the rising obesity rates among children and adolescents. In 2005, Congress passed the Child Nutrition Reauthorization Act, requiring all U.S. schools to develop goals to improve nutrition in school meals. Numerous nutrition standards have been proposed in the last several years, with flavored milks being an important part of most such proposals. For example, the government has promoted the “Let's Move” program to improve children's health. This initiative includes reforms to the U.S. school lunch program and encourages participation in the National School Breakfast Program, and challenges schools to serve more whole grains, fruits, and vegetables, while reducing the amount of sugar and sodium in school menus. Furthermore, on Jan. 13, 2011, the U.S. Department of Agriculture (USDA) published proposed rules on “Nutrition Standards in the National School Lunch and School Breakfast Programs” (76 FR 2494). Among other recommendations, the proposed program would increase the availability of fat-free and low-fat fluid milk in school meals to help meet the nutrition needs of school children within their calorie requirements.

More recently, on Jan. 31, 2011, the USDA published more general dietary guidelines recommending increased intake of fat-free or low-fat milk and milk products, among other items. (U.S. Department of Agriculture and U.S. Department of Health and Human Services. Dietary Guidelines for Americans, 2010. 7th Edition, Washington, D.C.: U.S. Government Printing Office, December 2010). The USDA guidelines recommend 3 cups per day of fat-free or low-fat milk and milk products for adults and children and adolescents ages 9 to 18 years, 2.5 cups per day for children ages 4 to 8 years, and 2 cups for children ages 2 to 3 years. The guidelines also note the importance of establishing milk and dairy consumption in children, as it leads to increased consumptions of milk as adults. Moreover, the guidelines suggest that added fats or sugars are best used to increase the palatability of nutrient dense foods, and list fat-free chocolate milk as an example.

Research has shown that children prefer flavored milk to white milk. Traditional flavored milk, such as chocolate milk, provides a good or excellent source of at least 9 essential vitamins and nutrients (e.g., protein, calcium, vitamin D, potassium, phosphorous, vitamin A, vitamin B12, riboflavin, and niacin). Flavored milks such as chocolate milk are very popular in various populations such as school-age children, and are an excellent source of many of the above vitamins and nutrients for these people. However, in its typical form it is significantly higher in calories than its white milk counterpart (180 calories for low fat chocolate milk versus 110 calories for low fat white milk, and about 150 calories for fat free chocolate milk versus 80 calories for fat free milk). It is also higher in sugar than white milk (30 grams sugar for chocolate milk versus 12 grams sugar for unflavored milk). Therefore, sweetened, flavored milks such as chocolate milk have not been a desirable choice for those attempting to reduce their caloric and sugar intake.

In an effort to reduce dietary sugar and prevent obesity in children, some school districts across the country have limited the sale of chocolate milk in schools. However, studies have shown that banning chocolate milk altogether in schools may result in a dramatic reduction in overall consumption of milk by school-age children. As a result, the limiting of chocolate milk may result in children in those districts not receiving the nutritional benefits that milk provides.

Because skim milk contains 80 calories per serving, a significant challenge exists for developing flavored milk products that maintain the desired taste and organoleptic properties of traditional chocolate milk, while remaining low in calories (e.g., about 100 calories per serving). In addition, it has been more difficult to develop low calorie and low sugar chocolate milks than other flavors, in part because more sweetener may be required to achieve an acceptable flavor that offsets the natural bitterness of the cocoa in typical chocolate milk.

Previous attempts have not been able to solve the problem of achieving comparable organoleptic characteristics to traditional flavored milk products while reducing calories, sugar, and fat. Some attempts include “dairy beverage” products, which contain milk and water, and often have watered-down qualities. In addition, federal and local programs such as the school lunch program often require milk products, not dairy beverages, due in part to nutritional considerations. Moreover, milk products must meet certain cost restraints to be suitable for school lunch budgets.

Additional attempts to reduce calories include use of non-nutritive artificial sweeteners such as sucralose, acesulfame potassium, or aspartame. Substitute milk products using these non-nutritive sweeteners often had inferior qualities such as insufficient body and mouthfeel, or poor flavor characteristics (weak, unbalanced, or artificial flavor). According to Krautheim A M, Dairy Management Institute, National Dairy Counsel (May 2007), reduced-calorie milk products formulated with non-nutritive sweeteners were not acceptable for use in dairy beverages. As these products have artificial ingredients, they are frequently less desirable to consumers, and are especially discouraged for consumption by children. Moreover, it was also found that there were aftertaste issues with these non-nutritive sweeteners.

The compositions and methods described herein provide the opportunity for consumers to enjoy the flavor and essential vitamins and nutrients of flavored milk while maintaining a diet that is reduced in calories and sugar. The products of this invention provide consumers with a reduced-calorie, reduced sugar, fat-free or low fat flavored milk that has comparable flavor and essential nutrients of higher calorie and sugar counterparts.

In some embodiments, the reduced-calorie flavored milk products described herein comprise low-fat or skim milk, a natural non-nutritive sweetener, and a flavoring agent. In certain embodiments, the flavored milk product further comprises a masking agent and/or flavor enhancer. Some products of the invention have less than 135 calories per serving. In another embodiment, the milk product has less than 110 calories per serving. One embodiment includes a milk product with about 100 calories per serving.

Some embodiments of the invention include reduced-calorie chocolate milk. In some embodiments, the natural sweetener is rebiana. In additional embodiments, the masking agent is chosen from a bitter blocker, acid blocker or metallic blocker. In one embodiment, the flavoring agent is cocoa. Certain milk products of the invention further comprise sugar.

In one embodiment, the reduced-calorie flavored milk product contains at least 94% skim milk, about 0.002-0.03% natural non-nutritive sweetener, about 0.01-0.3% masking agent and/or flavor enhancer, and about 0.5-0.7% flavoring agent by weight. In further embodiments, the milk product may also contain about 0-7% sugar, about 0-0.1% of a thickener, and 0.01-0.03% of a stabilizer by weight.

Certain embodiments include methods for producing a reduced-calorie flavored milk product. The milk product may have less than 135 calories per serving. The methods include the step of mixing low fat or skim milk, a sugar source, a stabilizer, and a non-nutritive sweetener. A cocoa flavoring agent can also be added to the mixture. In one embodiment, the non-nutritive sweetener is a natural sweetener, such as rebiana. In certain embodiments, a masking agent or flavor enhancer is also added to the skim milk mixture. The method further includes adding a vitamin supplement, such as vitamins A and D, then blending the mixture for a desired amount of time. In one embodiment, the mixture is blended for at least 10 minutes.

In certain embodiments, the methods include standardizing the blended product to a desired amount of total solids. In one embodiment, the desired amount of total solids is about 10-11%. Additional embodiments include heating the standardized product to at least 150° F. for at least 2 seconds. In one embodiment, the milk is heated to about 160 to 180° F. for about 15 to 30 seconds. In another embodiment, the milk is heated to about 280 to 300° F. for at least 2 seconds. Some embodiments include homogenizing the product. The homogenization step may be performed before or after the heat treatment step. In some embodiments, the product is homogenized at a pressure of about 1,000 to about 1,300 psi. In other embodiments, the product is homogenized at a pressure of about 2,000 to about 2,500 psi. In one example, the homogenization occurs at about 1,300 psi and a temperature of about 140 to about 170° F.

Additional embodiments of the invention are discussed throughout this application. Other objects, features, and advantages of the present invention will become apparent from the following detailed description. Any embodiment discussed with respect to one aspect of the invention applies to other aspects of the invention as well and vice versa. The embodiments in the Example section are understood to be embodiments of the invention that are applicable to all aspects of the invention.

It should be understood, however, that the detailed description and the specific examples, while indicating specific embodiments of the invention, are given by way of illustration only, since various changes and modifications within the spirit and scope of the invention will become apparent to those skilled in the art from this application.

### DESCRIPTION OF THE EMBODIMENTS

To assist in understanding the present invention, certain terms are first defined. Additional definitions are provided throughout the application.

The use of the word “a”, “an” or “the” when used in conjunction with the term “comprising” in the claims and/or the specification may mean “one,” but it is also consistent with the meaning of “one or more,” “at least one,” and “one or more than one.”

As used herein, the term “milk product” includes dairy products with at least 8.25% non-fat milk solids (MSNF). Milk product can refer to whole milk, reduced-fat milk, low-fat milk, or skim (also referred to non-fat or fat-free) milk products. By definition, skim milk contains no more than 0.25% fat or 0.5 g of fat per serving.

The term “serving” when used in relation to a milk product, refers to 8 fluid ounces.

As used herein, the term “organoleptic” relates to sensory properties, such as aroma, color, texture (including mouthfeel), and flavor (including taste and aftertaste). The organoleptic properties of milk can be assessed by sensory evaluations, but can also include measurements of viscosity, density, vapor pressure, and flavor intensity, among others. Additional methods of measuring sensory qualities are known to those skilled in the art (see, e.g., Hough et al., Food Quality and Preference 8(3):213-221 (1997); Judging and Scoring Milk and Cheese, USDA Farmers' Bulletin 2259 (2000); Sensory Evaluation of Dairy Products, Dairy Industry Technology Review (October 2005)).

I. Reduced-Calorie Flavored Milk

In some embodiments, the milk product contains skim or low-fat milk, a natural non-nutritive sweetener, a masking agent and/or flavor enhancer, and a flavoring agent. The milk products described herein have less than 135 calories per serving. In certain embodiments, the milk product has less than 130, 120, 110, 100, or 90 calories per serving. In additional embodiments, the milk product has 90-135, 90-120, 90-110, 90-100, 100-110, or 95-105 calories per serving. In some embodiments, the milk product has about 90, about 100, or about 110 calories per serving.

In certain embodiments, the milk product contains at least 93, 94, 95, 96, 97, 98, or 99% skim milk or low-fat milk. In one embodiment, the milk product contains about 97% skim milk. In certain embodiments, the milk product contains between trace amounts and 1% fat. In additional embodiments, the milk product contains less than 0.25% fat. The milk product may optionally contain 0-4.0% non-fat dry milk, or 0-10% condensed skim milk.

Certain embodiments of the invention include reduced calorie dairy beverages. Dairy beverages are currently defined by the USDA to contain less than 8.25% milk solids MSNF, and in some embodiments may be produced by mixing dry milk solids with an aqueous solution. Dairy beverages are currently categorized by the USDA as Class I (6.5-8.25% MSNF or greater than or equal to 2.25% milk protein) or Class II (less than 6.5% MSNF and less than 2.25% milk protein). These definitions may be changed by the USDA over time.

A. Sweeteners

In some embodiments, the milk product contains a natural non-nutritive sweetener. One example of a natural non-nutritive sweetener is rebiana (sometimes sold commercially under the names Stevia, Truvia, PureVia, Good and Sweet, Rebpure, and Reb-A). Rebiana was first approved for consumer use in the U.S. in December 2008, and is an all-natural sweetener that is approximately 200 times sweeter than sucrose. In some applications, rebiana may have undesirable aftertastes (e.g., bitterness or licorice flavors). These off-flavors tend to be more noticeable in beverages with near-neutral pH, such as milk. Therefore, rebiana has previously been believed to be unacceptable for milk beverages. Surprisingly, it has now been discovered that in certain formulations such as those set out in this application, rebiana can be used to produce flavored milk products that have significantly reduced levels of calories and sugar, while maintaining the desired organoleptic properties of traditional chocolate milk. Moreover, the use of rebiana has allowed for the addition of flavor to skim or low-fat milk without the addition of significant calories, as set forth in the present application.

In certain embodiments, the milk product contains between 0.002 and 0.03% natural non-nutritive sweetener, such as rebiana, by weight. In additional embodiments, the milk product contains 0.005-0.03, 0.01-0.03, 0.01-0.02, or 0.010 to 0.015% non-nutritive sweetener by weight. In one embodiment, the amount of non-nutritive sweetener is approximately 0.008, 0.012, or 0.016% rebiana.

In some products, the non-nutritive sweetener can be used in combination with nutritive sweeteners, including sugars such as sucrose, glucose, fructose, corn syrup, and high-fructose corn syrup. The sugar can be added to the milk product in crystallized, powdered, or liquid form.

In some embodiments, the milk product contains about 0-7, 0-4, 1-3, or 2-3% sugar by weight. In products using crystalline sugar (i.e., non-liquid sugar), the amount of sugar can be 0-5, 0-3, or 1-2% by weight. In one embodiment, the milk product contains about 2.2% liquid sugar. In another embodiment, the sugar is high fructose corn syrup. Generally, the amounts of non-nutritive sweetener and sugar will be coordinated to achieve a desired taste and level of calorie and/or sugar reduction.

In some embodiments, the milk products have about 12-20 g or 14-17 g of sugar per serving. In one embodiment, the flavored milk product has about 15 g of sugar per serving.

B. Masking Agents, Flavor Enhancers, and Flavoring Agents

In certain embodiments, the milk product also contains a masking agent and/or a flavor enhancer. The milk product may contain about 0.01-0.3% masking agent and/or flavor enhancer. A variety of masking agents are known in the flavor and food industry, and can be used to block unpleasant flavors from product components such as the non-nutritive sweetener or vitamin additives. Exemplary masking agents include bitter blockers, acid blockers, and metallic blockers. In some embodiments, two or more masking agents are used in combination.

A flavor enhancer, such as a sweetness enhancer, may be used instead of or in combination with a masking agent. Many flavor enhancers are known in the art and commercially available, and may provide a specific flavor (e.g., vanilla) in addition to enhancing flavors or sweetness. Flavor enhancers and masking agents can be obtained, for example, from Cargill, Dairy House, Virginia Dare, Kerry, Vanlab, Target Flavors, Edgar A. Weber & Co., Comax, and Symrise, among others. In one embodiment, the flavor enhancer or masking agent is Cargill Natural Vanilla Sugar Flavor. In other embodiments, it is Symrise Natural Bitterness Masker, Comax Natural Stevia Masking Flavor, or Comax Natural Sweetness Enhancer.

In some embodiments, the milk product contains a flavoring agent. In some instances, a single additive can simultaneously act as a masking agent, flavor enhancer, and/or flavoring agent. In certain embodiments, more than one masking agent, flavor enhancer, or flavoring agent can be used in combination. A number of commercially available flavoring agents are available. Some examples that work particularly well include cocoa, vanilla, strawberry, or coffee flavoring agents, but any suitable flavor can be added to the milk product. In some embodiments, the milk product contains about 0.5-1.0% flavoring agent. In certain embodiments, the flavoring agent is a chocolate flavoring agent such as Dairy House cocoa dairy powder.

C. Additional Ingredients

In additional embodiments, the milk product may contain a thickener or a stabilizer, or combinations thereof. Thickeners can increase the viscosity of a liquid, provide body and can improve the organoleptic properties of a milk product. Generally, thickeners do not alter the flavor of the milk product. Exemplary thickeners can be based on polysaccharides (starches, vegetable gums, and pectin) or proteins, and include arrowroot, cornstarch, katakuri starch, potato starch, sago, tapioca, alginin, guar gum, locust bean gum, xanthan gum, collagen, egg whites, furcellaran, gelatin, agar, and carrageenan, among others. In one embodiment, the thickener is guar gum. In some embodiments, the milk product contains 0-0.1% thickener.

Certain embodiments include stabilizers, which can stabilize and help achieve a more uniform texture. The milk products described herein may contain about 0.01-0.03% stabilizer by weight. Some thickeners, such as carrageenan, have both thickening and stabilizing properties. Other exemplary stabilizers include agar, pectin, and gelatin. Some flavoring agents also contain thickeners or stabilizers, making it unnecessary to separately add those ingredients.

In certain embodiments, the milk product has substantially the same vitamin content as low fat or skim white milk (i.e., unflavored, unsweetened milk). In some embodiments, the milk product contains added vitamins, such as vitamins A, C, D, and combinations thereof. The milk product may contain about 0.005% Vitamin C (ascorbic acid), about 0.001% Vitamin A, about 0.001% Vitamin D3, and/or about 0.0002% Vitamin D2. In additional embodiments, the milk product may contain added sources of calcium, including tricalcium phosphate. Other sources of calcium may also include, for example, calcium carbonate, calcium citrate, and calcium lactate. Calcium may be added in amounts resulting in 30-60% of the recommended daily allowance of calcium per serving of milk. In one example, a milk product contains about 0-1% tricalcium phosphate, in another example about 0.1-0.3% tricalcium phosphate, and in a further example about 0.24% tricalcium phosphate.

D. Milk Product Characteristics and Nutritional Information

The reduced-calorie flavored milk products described herein may have substantially the same organoleptic properties as traditional flavored milk products. For example, the milk products may have viscosity, density and/or vapor pressure that is within 1, 2, 3, 4, 5, or 10% of that typically measured in traditional flavored milks. In certain embodiments, the organoleptic properties can be measured by taste surveys or other methods that are known in the field of dairy products. See, e.g., Judging and Scoring Milk and Cheese, USDA Farmers' Bulletin 2259 (2000); Sensory Evaluation of Dairy Products, Dairy Industry Technology Review (2005); Milk Grading and Defects, http://www.foodsci.uoguelph.ca/dairyedu/grading.html).

As discussed above, the ingredients and processes described in the present application may result in a variety of flavored milk products having a range of nutritional values (such as carbohydrates, sodium, cholesterol, and protein). For example, in certain embodiments, the milk product has a carbohydrate content of from approximately 12 to 25 g per serving. In a more specific embodiment, the carbohydrate content will be approximately 15 to 20 g per serving. In one specific example shown below, the carbohydrate content will be approximately 17 g per serving. In certain embodiments, the milk product will have a sodium content of approximately 240 mg per serving, but this can vary between any acceptable range, such as between 120 to 300 mg per serving. In one specific example below, the cholesterol content is less than 5 mg per serving. Certain products such as low fat products (versus non-fat products), can have up to approximately 16 mg of cholesterol per serving. In certain embodiments, the protein content of the milk product will be approximately 6 to 16 g per serving. In a more specific embodiment, the protein content will be approximately 8 to 12 g per serving. In one specific example shown below, the protein content will be 8 g per serving.

The nutritional contents for one specific example of a reduced calorie flavored milk product under the present invention are provided below by way of example only. In this example, one serving of the milk product has the following nutritional values: Calories: 100; Calories from Fat: 0; Total Fat: 0 g (0% Daily Value (DV), based on 2,000 calorie diet); Saturated Fat: 0 g (1% DV); Trans Fat: 0 g; Cholesterol: less than 5 mg (1% DV); Sodium: 240 mg (10% DV); Total Carbohydrate: 17 g (6% DV); Dietary Fiber: 0 g (0% DV); Sugars: 15 g; Protein: 8 g (17% DV). In this example, the percent of Daily Value of other nutrients is as follows: Vitamin A: 10%; Vitamin C: 10%; Calcium: 30%; Iron: 0%; Vitamin D: 25%. It should be understood that these nutritional values are provided by way of example only. In this specific example, the label of the flavored milk product would list the following ingredients: fat free milk, high fructose corn syrup (or sugar), cocoa processed with alkali, corn starch, salt, carrageenan, natural and artificial flavor, rebinia, ascorbic acid (Vitamin C), Vitamin A Palmitate, and Vitamin D2.

Table 1 provides the compositions of several exemplary flavored milks as described herein.

TABLE 1
Flavored Milk Compositions

| | | Ex. 2 | Ex. 3 | Ex. 4 | Ex. 5 |
|---|---|---|---|---|---|
| Ingredient | Ex. 1 (%) | (%) | (%) | (%) | (%) |
| Skim Milk | 97.16 | 97.06 | 97.14 | 96.77 | 94.80 |
| Cream | 0 | 0 | 0 | 0 | 2.00 |
| Sugar (liquid sugar | 2.200 | 2.200 | 2.200 | 2.000 | 2.000 |
| or HFCS) | | | | | |
| Flavoring Agents | 0.570 | 0.570 | 0.570 | 0.800 | 0.800 |
| Thickeners | 0.050 | 0.050 | 0.075 | 0.050 | 0.030 |
| Stabilizers | 0 | 0 | 0 | 0.025 | 0.018 |
| Rebiana | 0.012 | 0.012 | 0.012 | 0.016 | 0.016 |
| Flavor Enhancers and/ | 0 | 0.100 | 0 | 0.100 | 0.100 |
| or Masking Agents | | | | | |
| Vitamin A | 0.001 | 0.001 | 0.001 | 0.001 | 0.001 |
| Vitamin D3 | 0 | 0 | 0 | 0.001 | 0.001 |
| Vitamin D2 | 0.0002 | 0.0002 | 0.0002 | 0 | 0 |
| Vitamin C | 0.005 | 0.005 | 0.005 | 0 | 0 |
| Tricalcium phosphate | 0 | 0 | 0 | 0.240 | 0.240 |

IV. Production Processes

In certain embodiments, the invention includes a method of producing a reduced-calorie flavored milk product. In some embodiments, the ingredients of the milk product are mixed in a batch tank. In one embodiment, the tank is connected to a liquefier.

The milk product can be prepared by adding sugar, non-sugar sweetener, flavoring agent, and optional masking agent, flavor enhancer, thickeners, stabilizers, and vitamins, to milk. The mixture can be stirred during or between additions of various agents, or multiple components can be added before mixing.

In one example, the ingredients can be added in the following order: 1) add skim milk, then sugar to the batch tank; 2) add thickener (e.g., guar gum) to the liquefier, followed by cocoa flavoring, rebiana, flavor enhancer and/or masking agent if used, then vitamins; 3) continue recirculation between the batch tank and liquefier for at least 10 minutes.

In some embodiments, the mixture is recirculated between the batch tank and liquefier for at least 5, 10, 15, or 20 minutes. In additional embodiments, the mixture is blended in the batch tank for at least 15, 20, 25, or 30 minutes.

After blending, total solids and fat may be standardized to desired values. In some embodiments, total solids are standardized to about 8-12, 9-11, or 10-11%. In additional embodiments, fat is standardized to about 0.0-0.2, 0.0-0.5, 0-1, 1-2, or 0-2%.

In certain embodiments, the milk product is processed by heating. The milk product may be heated to at least 150° F. for at least 2 seconds. In general, higher temperatures require shorter lengths of time for heat treatment. Certain embodiments include heating to at least, 160, 165, 170, or 180° F. for at least 15, 20, 30, 40, 50, or 60 seconds. This is generally referred to as a High Temperature Short Time (HTST) pasteurization process. In one HTST embodiment, the milk product is heated at approximately 180° F. for approximately 30 seconds. In another HTST embodiment, the milk product is heated to about 160° F. for approximately 15 seconds. In still another HTST embodiment, the milk product is heated to a temperature of about 160 to 180° F. for about 15 to 30 seconds. In a separate embodiment, generally referred to as an Ultra High Temperature (UHT) process, the milk product is heated to about 280 to 300° F. for about 2 to 3 seconds. After UHT processing, the milk is cooled. In one embodiment, the UHT milk can be stored under refrigeration with an extended shelf life of approximately 60 days. In another embodiment, the milk product is heated to about 145-152° F. for at least 30 minutes. This is generally referred to as a Low Temperature Long Time (LTLT) pasteurization process. These processes may be performed as continuous or batch processes.

A further embodiment includes an aseptic process that involves heating the milk product to about 280 to 300° F. for about 6 to 15 seconds. In certain embodiments, the milk product is heated to about 285 to 295° F. In other embodiments, the milk product is heated for about 8 to 10 seconds. The product made by this process is packaged into containers that are commercially sterilized, and can be stored under ambient conditions (i.e., without refrigeration).

In additional embodiments, the milk product is homogenized. In one embodiment, homogenization can be performed at about 1,300 psi, although various pressures suitable for homogenization can be used. For example, pressures in the range of 1,000 to 3,000 psi may be used. For certain processes, a pressure of about 1,000 to about 1,300 psi may be used. Other processes can use higher pressures, such as in the range of about 2,000 to 2,500 psi for homogenization. The homogenization step may occur after the heat treatment process (post-processing), or before heat treatment, for example at an intermediate temperature in the heating process (pre-processing). In certain embodiments of pre-processing, the homogenization may occur at approximately 140 to 170° F. In one example of pre-processing homogenization, the milk is treated at about 1,300 psi and about 150 to 160° F. After the heating and homogenization steps, the milk product is then cooled to lower temperatures, in one embodiment, less than 40 degrees F. The product is then ready for the filling of suitable containers.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

All references cited herein are incorporated herein by reference in their entirety. To the extent publications and patents or patent applications incorporated by reference contradict the invention contained in the specification, the specification will supersede any contradictory material.

What is claimed is:

1. A reduced-calorie flavored milk product comprising low-fat or skim milk, a natural non-nutritive sweetener, and a flavoring agent, wherein the milk product has less than 135 calories per serving.

2. The product of claim 1, wherein the natural sweetener is rebiana.

3. The product of claim 2, wherein the flavoring agent is a cocoa flavor.

4. The product of claim 2, wherein the milk is skim milk.

5. The product of claim 2, further comprising a masking agent or flavor enhancer.

6. The product of claim 5, wherein the masking agent is chosen from a bitter blocker, an acid blocker, and a metallic blocker.

7. The product of claim 1, further comprising sugar.

8. The product of claim 1, further comprising high fructose corn syrup.

9. The product of claim 7, wherein the milk product has less than 110 calories per serving.

10. The product of claim 9, wherein the milk product has about 100 calories per serving.

11. The product of claim 5, wherein the milk product contains at least 94% skim milk, about 0.002-0.03% natural non-nutritive sweetener, about 0.01-0.3% masking agent, and about 0.5-0.7% flavoring agent by weight.

12. The product of claim 11, further comprising about 0-7% sugar, about 0-0.1% of a thickener, and 0.01-0.03% of a stabilizer by weight.

13. The product of claim 1, wherein the flavored milk product is a chocolate milk.

14. A method for producing a reduced-calorie flavored milk product comprising the steps of:
a. mixing low fat or skim milk, a sugar source, a stabilizer, and a non-nutritive sweetener;
b. adding a vitamin supplement to the product of step a;
c. blending the product of step b for a desired amount of time;
d. standardizing the product of step c to a desired amount of total solids; and
e. heating the product of step d to at least 150° F. for at least 2 seconds.

15. The method of claim 14, wherein the non-nutritive sweetener is a natural sweetener.

16. The method of claim 15, wherein the non-nutritive sweetener is rebiana.

17. The method of claim 16, wherein the reduced-calorie flavored milk product has less than 135 calories per serving.

18. The method of claim 14, wherein the desired amount of time is at least 10 minutes.

19. The method of claim 14, wherein the desired amount of total solids is about 10-11%.

20. The method of claim 14, further comprising adding a masking agent or flavor enhancer to the mixture of step a.

21. The method of claim 14, further comprising a homogenization step.

22. The method of claim 21, wherein the homogenization step occurs at about 1,000 to 1,300 psi.

23. The method of claim 21, wherein the homogenization step occurs at about 2,000 to 2,500 psi.

24. The method of claim 21, wherein the homogenization step is performed after step e.

25. The method of claim 21, wherein the homogenization step is performed before step e.

26. The method of claim 25, wherein the homogenization step occurs at about 1,000 to 1,300 psi and at a temperature of about 140 to 170° F.

27. The method of claim 14, wherein the milk product is heated to about 280 to 300° F. for at least 2 seconds in step e.

28. The method of claim 14, wherein the milk product is heated to about 160 to 180° F. for about 15 to 30 seconds in step e.

29. A method for producing a reduced-calorie flavored milk product comprising the steps of:
a. mixing low fat or skim milk, a sugar source, a stabilizer, a cocoa flavoring agent, and rebiana;
b. adding vitamins A and D to the product of step a;
c. blending the product of step b for at least 10 minutes;
d. standardizing the product of step c to about 10-11% total solids;
e. homogenizing the product of step d at a pressure of about 1,300 psi and a temperature of about 140 to 170° F.; and
f. heating the product of step d to at least 180° F. for at least 15 seconds.
